(19) United States
(12) Patent Application Publication
(10) Pub. No.: US 2026/0231156 A1
(43) Pub. Date: Aug. 6, 2026

(54) METHOD AND APPARATUS FOR RECEIVING OR TRANSMITTING DATA OR CONTROL INFORMATION IN A WIRELESS COMMUNICATION SYSTEM

(71) Applicant: SAMSUNG ELECTRONICS CO., LTD., Suwon-si, Gyeonggi-do (KR)

(72) Inventors: Jingxing FU, Beijing (CN); Feifei SUN, Beijing (CN); Zhe CHEN, Beijing (CN)

(21) Appl. No.: 19/146,181

(22) PCT Filed: Jan. 9, 2024
(86) PCT No.: PCT/KR2024/000386

§ 371 Date: Jul. 7, 2025

(30) Foreign Application Priority Data
Jan. 9, 2023 (CN) 202310028476.5

(51) Int. Cl. H04W 72/21; H04W 72/0453

(52) U.S. Cl. CPC H04W 72/21; H04W 72/0453

(57) ABSTRACT

The disclosure relates to a 5G or 6G communication system for supporting a higher data transmission rate. The method performed by a terminal in a communication system, includes: determining frequency domain resources related to a Physical Uplink Shared Channel (PUSCH) transmission; and determining resources occupied by Uplink Control Information (UCI) multiplexed in a PUSCH based on the frequency domain resources related to the PUSCH transmission; transmitting the UCI based on the determined resources occupied by the UCI multiplexed in the PUSCH; wherein, the frequency domain resources related to the PUSCH transmission include frequency domain resources assigned to the PUSCH and/or frequency domain resources available for the PUSCH transmission among the frequency domain resources assigned to the PUSCH.

### TECHNICAL FIELD

The present application relates to a field of wireless communication technologies, and more particularly, to a method performed by a user equipment and a method performed by a base station, as well as the user equipment and the base station.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

Currently, there are needs to enhance radio link monitoring in wireless communication system.

### Solution to Problem

According to one aspect of the present disclosure, there is provided a method performed by a User Equipment (UE) (or, a terminal) in a communication system; the method may include: determining frequency domain resources related to a Physical Uplink Shared Channel (PUSCH) transmission; determining resources occupied by Uplink Control Information (UCI) multiplexed in a PUSCH based on the frequency domain resources related to the PUSCH transmission; and transmitting the UCI based on the determined resources occupied by the UCI multiplexed in the PUSCH; wherein, the frequency domain resources related to the PUSCH transmission may include frequency domain resources assigned to the PUSCH and/or frequency domain resources available for the PUSCH transmission among the frequency domain resources assigned to the PUSCH.

In some implementations, in the above-described method performed by the UE, the frequency domain resources assigned to the PUSCH may be frequency domain resources indicated by a Frequency Domain Resource Assignment (FDRA) in the downlink control information scheduling the PUSCH and/or frequency domain resources configured for the PUSCH using higher-layer signaling.

In some implementations, in the above-described method performed by the UE, frequency domain resources available for PUSCH transmission among the frequency domain resources assigned to the PUSCH may be determined, based on the frequency domain resources assigned to the PUSCH and the frequency domain resources available and/or unavailable for PUSCH transmission.

In some implementations, in the above-described method performed by the UE, the frequency domain resources available and/or unavailable for PUSCH transmission may be determined based on indication information; the indication information may include at least one of higher-layer signaling configuration information, information indicated by a media access control layer signaling, information indicated by a physical layer signaling, and information indicated by a reference signal; and wherein the indication information may include at least one of the number and/or positions of downlink frequency domain resource units, the number and/or positions of uplink frequency domain resource units, the number and/or positions of flexible frequency domain resource units, and the number and/or positions of frequency domain resource units of a guard band.

In some implementations, in the above-described method performed by the UE, the frequency domain resources available for PUSCH transmission may be available frequency domain resources within a serving cell, a carrier, or a BandWidth Part (BWP).

In some implementations, in the above-described method performed by the UE, the frequency domain resources unavailable for PUSCH transmission may include at least one of: frequency domain resources other than uplink frequency domain resources; frequency domain resources other than uplink frequency domain resources and flexible frequency domain resources; downlink frequency domain resources; flexible frequency domain resources; and frequency domain resource of a guard band.

In some implementations, in the above-described method performed by the UE, the frequency domain resources available for PUSCH transmission may include at least one of: uplink frequency domain resources; flexible frequency domain resources; frequency domain resources other than downlink frequency domain resources; frequency domain resources other than downlink frequency domain resources and flexible frequency domain resources; and frequency domain resources other than downlink frequency domain resources and frequency domain resources of a guard band.

In some implementations, in the above-described method performed by the UE, a manner for determining resources occupied by the UCI multiplexed in the PUSCH may include at least one of: determining the resources occupied by the UCI multiplexed in the PUSCH, according to the number of subcarriers available for UCI multiplexing among the number of subcarriers of the frequency domain resources available for PUSCH transmission among the frequency domain resources assigned to the PUSCH; determining the resources occupied by the UCI multiplexed in the PUSCH, according to the number of subcarriers of the frequency domain resources assigned to the PUSCH; and determining the resources occupied by the UCI multiplexed in the PUSCH, according to the number of subcarriers of the frequency domain resources assigned to the PUSCH, and the number of subcarriers available for PUSCH transmission among the number of subcarriers of the frequency domain resources assigned to the PUSCH.

In some implementations, in the above-described method performed by the UE, the resources occupied by the UCI multiplexed in the PUSCH may be the number of coded modulation symbols.

In some implementations, in the above-described method performed by the UE, the manner for determining resources occupied by UCI multiplexed in the PUSCH may be determined according to a signaling indication or a defined condition.

In some implementations, in the above-described method performed by the UE, the defined condition may include whether the PUSCH is a dynamically granted PUSCH or a configuration granted PUSCH.

In some implementations, in the above-described method performed by the UE, the signaling indication may include at least one of a higher-layer signaling configuration, a media access control layer signaling indication, or a physical layer signaling indication.

In some implementations, the above-described method performed by the UE may further include: selecting at least one PUSCH according to a priority to multiplex the UCI, the priority being a priority for multiplexing UCI in the PUSCH.

In some implementations, in the above-described method performed by the UE, a priority for multiplexing the UCI in the PUSCH whose assigned PUSCH frequency domain resources are all available for PUSCH transmission may be higher than a priority for multiplexing the UCI in the PUSCH whose assigned PUSCH frequency domain resources include frequency domain resources unavailable for PUSCH transmission; and/or the priority may be determined according to whether the assigned PUSCH frequency domain resources are all available or partially available for PUSCH transmission, and/or according to whether the PUSCH is a dynamically granted PUSCH or a configuration granted PUSCH.

According to another aspect of the present disclosure, there is provided a method performed by a base station in a communication system. The method may include: determining frequency domain resources related to a Physical Uplink Shared Channel (PUSCH) transmission; determining resources occupied by Uplink Control Information (UCI) multiplexed in a PUSCH based on the frequency domain resources related to the PUSCH transmission; and receiving the UCI based on the determined resources occupied by the UCI multiplexed in the PUSCH; wherein, the frequency domain resources related to the PUSCH transmission may include frequency domain resources assigned to the PUSCH or frequency domain resources available for the PUSCH transmission among the frequency domain resources assigned to the PUSCH.

According to another aspect of the present disclosure, there is provided a User Equipment (UE), and the UE may include: a transceiver, for transmitting and receiving signals; and a controller, coupled to the transceiver and configured to execute the above-described method performed by the UE.

According to another aspect of the present disclosure, there is provided a base station, and the base station may include: a transceiver, for transmitting and receiving signals; and a controller, coupled to the transceiver and configured to execute the above-described method performed by the base station.

According to another aspect of the present disclosure, there is provided a non-temporary computer-readable medium, having instructions stored thereon, when executed by one or more controllers, the instructions cause the one or more controllers to execute the above-described methods performed by the UE and/or the base station.

By using the present application, reasonable resources may be assigned for uplink control information more accurately, to better ensure reception performance of the uplink control information, and ensure data reception performance as far as possible while ensuring reception performance of the uplink control information.

### BRIEF DESCRIPTION OF DRAWINGS

The above-described and additional aspects and advantages of the present application will become more apparent and easier to understand through the following description in conjunction with the accompanying drawings, wherein:

FIG. 1 illustrates an example wireless network according to various embodiments of the present disclosure;

FIG. 2A illustrates an example wireless transmission and reception paths according to the present disclosure;

FIG. 2B illustrates an example wireless transmission and reception paths according to the present disclosure

FIG. 3A illustrates an example user equipment according to the present disclosure;

FIG. 3B illustrates an example base station according to the present disclosure;

FIG. 4 shows a schematic diagram of a configuration mode of some frequency domain resources corresponding to symbols or slots according to the embodiment of the present application;

FIG. 5 shows an exemplary flow chart of a method for transmitting PUSCH and/or determining resources occupied by UCI multiplexed in PUSCH according to an embodiment of the present application;

FIG. 6 shows a schematic diagram of frequency domain resources available/unavailable for PUSCH transmission according to the embodiment of the present application;

FIG. 7 shows a schematic diagram of frequency domain resources available/unavailable for PUSCH transmission and frequency domain resources indicated by a FDRA in DCI scheduling the PUSCH according to the embodiment of the present application.

FIG. 8 is a block diagram of a node according to an exemplary embodiment of the present disclosure.

FIG. 9 is a block diagram of a user equipment according to an exemplary embodiment of the present disclosure.

### BEST MODE FOR CARRYING OUT THE INVENTION

The following description with reference to the accompanying drawings is provided to facilitate comprehensive understanding of various embodiments of the present disclosure as defined by the claims and equivalents thereof. The description includes various specific details to facilitate understanding, but should be considered exemplary only. Therefore, those ordinarily skilled in the art will recognize that, various changes and modifications may be made to the various embodiments described herein without departing from the scope and spirit of the present disclosure. In addition, for clarity and conciseness, description of well-known functions and structures may be omitted.

The terms and wordings used in the following description and claims are not limited to their dictionary meaning, but are merely used by an inventor to enable a clear and consistent understanding of the present disclosure. Therefore, it should be apparent to those skilled in the art that, the following description of various embodiments of the present disclosure is provided for illustration purposes only and not for the purpose of limiting the scope of the present disclosure as defined by the appended claims and equivalents thereof.

It should be understood that, the singular forms of “a”, “an” and “the” include plural references unless the context clearly dictates otherwise. Thus, for example, a reference to a “component surface” includes a reference to one or more such surfaces.

The terms “include” or “may include” refer to presence of a correspondingly disclosed function, operation, or component that may be used in various embodiments of the present disclosure, rather than limiting presence of one or more additional functions, operations, or features. Furthermore, the terms “comprise” or “have” may be construed to indicate certain characteristics, numbers, steps, operations, constituent elements, components, or combinations thereof, but should not be construed as excluding possibility of presence of one or more other characteristics, numbers, steps, operations, constituent elements, components, or combinations thereof.

The term “or” as used in various embodiments of the present disclosure includes any of the listed terms and all combinations thereof. For example, “A or B” may include A, or may include B, or may include both A and B.

Unless defined differently, all terms (including technical or scientific terms) used in the present disclosure have the same meaning as understood by those ordinarily skilled in the art according to the present disclosure. Common terms as defined in dictionaries are to be construed to have meanings consistent with the context in the relevant technical field, and should not be construed ideally or overly formalized unless explicitly so defined in the present disclosure.

In order to meet the increasing demand for wireless data communication services since the deployment of 4G communication systems, efforts have been made to develop improved 5G or pre-5G communication systems. Therefore, 5G or pre-5G communication systems are also referred to as “Beyond 4G networks” or “Post-LTE systems”.

In order to implement a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud Radio Access Network (RAN), ultra-dense network, Device-To-Device (D2D) communication, wireless backhaul, mobile network, cooperative communication, Coordinated Multi-Points (CoMP), reception-end interference cancellation, etc.

In 5G systems, hybrid FSK and QAM modulation (FQAM) and Sliding Window Superposition Coding (SWSC) as Advanced Coding Modulation (ACM), and Filter Bank Multicarrier (FBMC), Non-Orthogonal Multiple Access (NOMA) and Sparse Code Multiple Access (SCMA) as advanced access technologies have been developed.

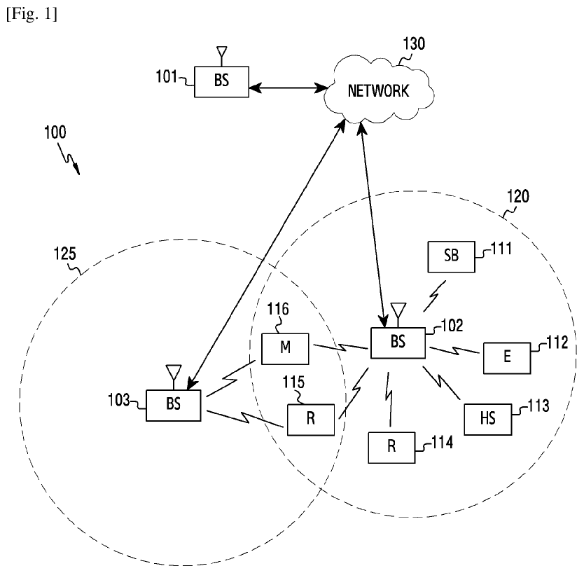

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (e.g., a mobile phone or a smart phone) or a fixed device (e.g., a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 may include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

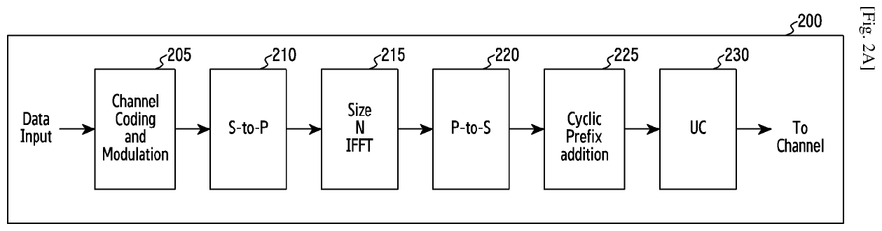

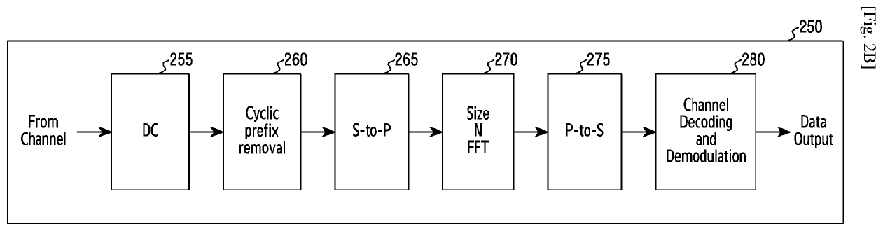

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (e.g., Low Density Parity Check (LDPC) coding), and modulates the input bits (e.g., using Quadrature Phase Shift Keying (QPSK) or Quadrature Amplitude Modulation (QAM)) to generate a sequence of frequency-domain modulated symbols. The Serial-to-Parallel (S-to-P) block 210 converts (e.g., demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (e.g., multiplexes) parallel time-domain output symbols from the Size N IFFT block 215 to generate a serial time-domain signal. The cyclic prefix addition block 225 inserts a cyclic prefix into the time-domain signal. The up-converter 230 modulates (e.g., up-converts) the output of the cyclic prefix addition block 225 to an RF frequency for transmission via a wireless channel. The signal may also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (e.g., 1, 2, 3, 4, etc.), while for FFT and IFFT functions, the value of variable N may be any integer which is a power of 2 (e.g., 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

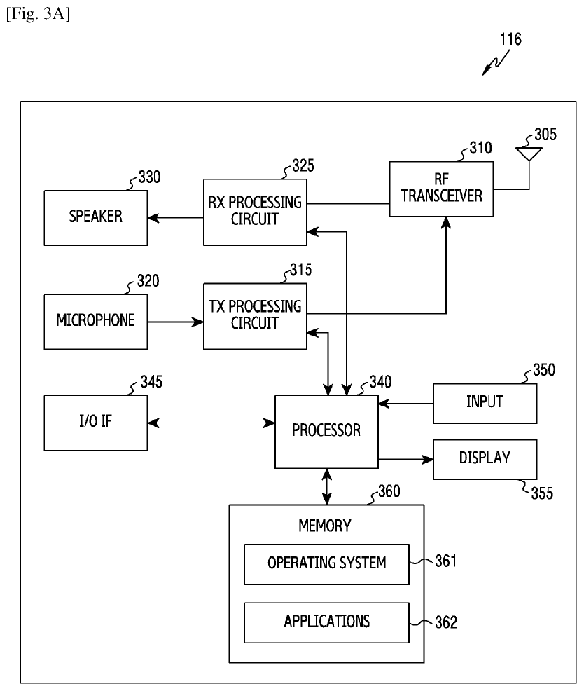

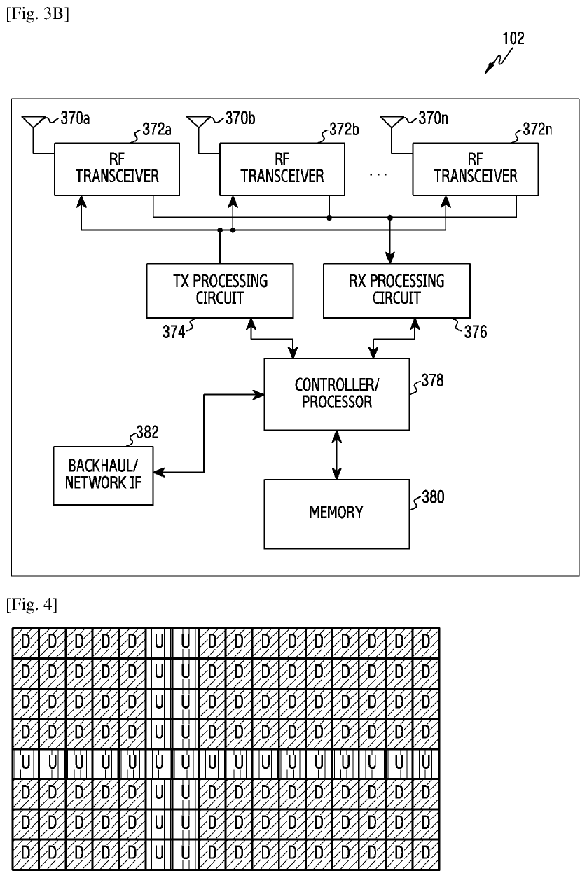

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (e.g., for voice data) or to processor/controller 340 for further processing (e.g., for web browsing data).

The TX processing circuit 315 receives analog or digital voice data from microphone 320 or other outgoing baseband data (e.g., network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (e.g., from a website). The memory 360 is coupled to the processor/controller 340. A part of the memory 360 may include a random access memory (RAM), while another part of the memory 360 may include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 may include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (e.g., voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 may include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 may also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 may also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 may include an RAM, while another part of the memory 380 may include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 may include any number of each component shown in FIG. 3A. As a specific example, the access point may include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 may include multiple instances of each (e.g., one for each RF transceiver).

Exemplary embodiments of the present disclosure are further described below in conjunction with the accompanying drawings.

The text and drawings are provided by way of examples only to assist the reader in understanding the present disclosure. They are not intended and should not be construed to limit the scope of the present disclosure in any way. Although certain embodiments and examples have been provided, it will be apparent to those skilled in the art based on the disclosure herein that the shown embodiments and examples may be modified without departing from the scope of the present disclosure.

Communication systems are usually divided into Time Division Duplexing (TDD) systems and Frequency Division Duplexing (FDD) systems. In the TDD system, a base station may configure uplink and downlink attributes of different time resources on a carrier through semi-static signaling and dynamic signaling, namely, uplink transmission slots/symbols, downlink transmission slots/symbols, and flexible slots/symbols. In the FDD system, a base station may respectively configure different time resources of an uplink carrier in a pair of uplink and downlink carriers as uplink transmission slots/symbols or flexible slots/symbols; and different time resources of a downlink carrier in the pair of uplink and downlink carriers as downlink transmission slots/symbols or flexible slots/symbols.

As compared with the FDD system, in the TDD system, time delay of uplink or downlink transmission is relatively large due to time division multiplexing of uplink and downlink transmission. For example, according to an uplink and downlink configuration, in a 10-millisecond (ms) cycle, only a 1-ms slot is for uplink transmission, while other slots are all for downlink transmission or flexible transmission; maximum latency for uplink transmission is 10 ms. In order to reduce transmission latency, it may be considered to divide some frequency domain resources in a carrier into uplink transmission and the other frequency domain resources into downlink transmission. In order to reduce mutual influence between uplink transmission and downlink transmission in a same carrier, manners such as guard interval and filtering may be used to reduce uplink and downlink interferences. Further, it may be considered to use some frequency domain resources in a carrier for both uplink transmission and downlink transmission, thereby improving resource utilization rate.

The exemplary embodiment of the present disclosure proposes to improve the existing method for multiplexing Uplink Control Information (UCI) based on a new uplink and downlink transmission mode, so as to ensure transmission performance of the UCI and ensure data transmission performance as far as possible while ensuring UCI transmission performance.

A time unit in the present disclosure may be, for example, a slot, a symbol, a subframe, a system frame, 1 second, 1 millisecond, etc., or any combination thereof. In the present disclosure, various aspects of the present disclosure are described by taking “one slot or symbol” as an example, but those skilled in the art should understand that it may be extended to other time units without departing from the scope of the present disclosure.

In the TDD system, the base station may indicate whether a slot or symbol is an uplink slot or symbol, or a downlink slot or symbol, or a flexible transmission slot or symbol; according to the indication information, the UE determines uplink and downlink transmission directions of respective symbols/slots of a carrier/serving cell. Usually, within a same symbol of a carrier/serving cell, only one direction of transmission is supported, that is, uplink transmission or downlink transmission. Therefore, the base station only needs to indicate the directions of uplink transmission and downlink transmission in a time dimension. The base station may periodically indicate, for example, a periodic slot configuration through higher-layer signaling, or a slot format over a period of time through dynamic signaling. Uplink and downlink attributes of respective frequency domain resources corresponding to each slot/symbol are determined through the slot configuration/format: for uplink transmission, for downlink transmission, or flexible transmission. A flexible slot/symbol may be used for both uplink transmission and downlink transmission, but may only be used for transmission in one direction at a certain moment. In the FDD system, with respect to an uplink carrier/serving cell, the base station may indicate symbols/slots for uplink or flexible transmission; and with respect to a downlink carrier/serving cell, the base station may indicate symbols/slots for downlink or flexible transmission. A first type of cell common UL/DL information may include information of the uplink and downlink attributes on the time dimension; the first type of cell common UL/DL information may be used to indicate a cycle, which slots/symbols in the cycle are respectively uplink, downlink, or flexible slots/symbols; and the indicated uplink and downlink attributes are applicable to all frequency domain resources corresponding to respective slots/symbols of the cell, that is, all frequency domain resources within a bandwidth of the carrier/serving cell have same uplink and downlink attributes within a slot/symbol.

In order to assign uplink and downlink transmission resources more efficiently, a granularity of the uplink and downlink transmission resources may be further reduced from a symbol/slot to some frequency domain resources corresponding to a symbol/slot through configuration information, that is, different frequency domain resources corresponding to a symbol/slot of a carrier/serving cell may be assigned with different transmission directions. The configuration information includes cell common UL/DL information and UE specific UL/DL information. The cell common UL/DL information may include information of uplink and downlink attributes in both time dimension and frequency dimension. The cell common UL/DL information may be used to indicate which frequency domain resources corresponding to which slots/symbols are resources for uplink, downlink, or flexibly transmission. Alternatively, the cell common UL/DL information may be used to indicate which frequency domain resources corresponding to which slots/symbols are resources for uplink and downlink transmission, or cannot be used for transmission. Further, with respect to a same time-frequency resource, the base station may also assign uplink transmission and downlink transmission simultaneously, to implement full duplex multiplexing. The base station may also configure user specific UL/DL information, for example, configure user specific UL/DL information for each serving cell of the UE, or configure user specific UL/DL information for each BandWidth Part (BWP) of the UE. According to the configured user specific UL/DL information, the UE may determine that some frequency domain resources corresponding to a symbol or slot are uplink transmission resources (represented by U), and some frequency domain resources are downlink transmission resources (represented by D), as shown in FIG. 4. As shown in FIG. 4, a horizontal axis represents symbols or slots, a vertical axis represents carriers, and one lattice represents one resource unit. Those skilled in the art should understand that the specific example provided in FIG. 4 is for illustrative purpose only and not for the purpose of limiting the present disclosure. According to the embodiment of the present disclosure, the configuration mode of some frequency domain resources corresponding to symbols or slots is not limited thereto.

Such situation in FIG. 4 will cause the uplink BWP to include a downlink frequency domain resource; and the frequency domain resource includes at least one frequency domain resource unit, for example: a Physical Resource Block (PRB) or a Resource Block (RB) or a downlink Resource Element (RE) or a Resource Element Group (REG, RE Group); or cause the downlink BWP to include an uplink frequency domain resource, for example, an uplink PRB, RB, or an uplink RE, REG. A problem brought about thereby is that some of the PRBs indicated through Frequency Domain Resource Assignment (FDRA) are actually unavailable, for example, the frequency domain resources assigned for the PUSCH include downlink frequency domain resources (e.g., PRBs, RBs, REs, REGs) or frequency domain resources (e.g., PRBs, RBs, REs, REGs) serving as isolation (e.g., a guard band), the downlink frequency domain resources or frequency domain resources serving as isolation are unavailable frequency domain resources (e.g., PRBs, RBs, REs, REGs), which may affect data reception performance.

The number of physical resource blocks (e.g., PRBs, RBs, REs, REGs) that transmit data is the number of frequency domain resources (e.g., PRBs, RBs, REs, REGs) indicated by FDRA in the Downlink Control Information (DCI) scheduling the PUSCH, or the number of frequency domain resources (e.g., PRBs, RBs, REs, REGs) configured for the PUSCH by using higher-layer signaling.

Then, the resources occupied by Uplink Control Information (UCI) multiplexed in the PUSCH are determined, according to the number of frequency domain resources indicated (by taking PRBs as an example). The resources occupied by the UCI in the PUSCH are calculated according to equation I below:

$${Q}_{UCI}^{′} = min \{ ⌈ \frac{( {O}_{UCI} + {L}_{UCI} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \} \qquad Equation I$$

The UCI in the equation may be one type of UCI among Hybrid Automatic Repeat Request-Acknowledgement (HARQ-ACK), Channel State Information (CSI), etc.;
Q′_{UCI} in the equation is the number of coded modulation symbols occupied by the UCI;
O_{UCI} in the equation is the number of bits of the UCI;
L_{UCI} is the number of bits scrambled by Cyclic Redundancy Check (CRC) of the UCI;

$${β}_{offset}^{PUSCH} = {β}_{offset}^{UCI}$$

is a weighting coefficient;
C_{UL-SCH} is the number of encoding blocks of the PUSCH;
Kᵣ is a size of an r-th encoding block of the PUSCH;

$${M}_{sc}^{UCI} ( l )$$

is the number of REs on an 1-th OFDM symbol of the PUSCH that are available for transmitting the UCI;

$${M}_{sc}^{UCI} ( l ) = {M}_{sc}^{PUSCH} - {M}_{sc}^{PT - RS} ( l ) ;$$

Wherein,

$${M}_{sc}^{PUSCH}$$

is a frequency domain bandwidth of the scheduled PUSCH, in subcarriers;

$${M}_{sc}^{PT - RS} ( l )$$

is the number of subcarriers carrying a Phase Tracking-Reference Signal (PT-RS) on the 1-th OFDM symbol of the PUSCH;
α is a weighting factor;

$${N}_{symb , all}^{PUSCH}$$

is the number of all OFDM symbols of the PUSCH;
I₀ is an index of a first OFDM in the PUSCH that does not have a Demodulation Reference Signal (DMRS);
┌ ┐ represents an operation of rounding up; and min{a, b} represents taking a minimum value between a and b.

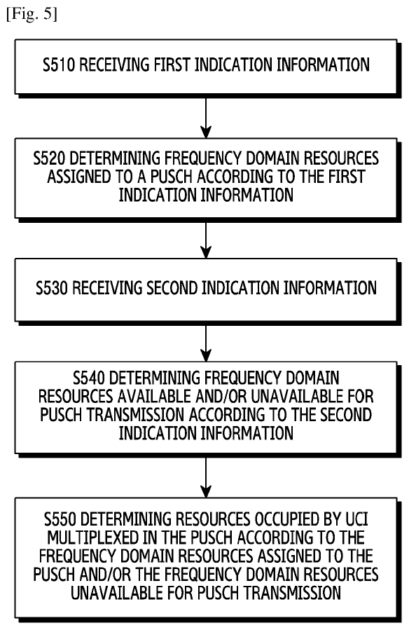

FIG. 5 shows an exemplary flow chart of a method 500 for transmitting PUSCH and/or determining resources occupied by UCI multiplexed in PUSCH according to an embodiment of the present disclosure. The method 500 is implemented on the UE side.

As shown in FIG. 5, in step S510 of the method 500, the UE receives first indication information.

In step S520, the UE determines frequency domain resources assigned to the PUSCH according to the first indication information.

In step S530, the UE receives second indication information.

In step S540, the UE determines frequency domain resources available or unavailable for PUSCH transmission according to the second indication information.

In step S550, the UE determines resources occupied by UCI multiplexed in the PUSCH according to the frequency domain resources assigned to the PUSCH and the frequency domain resources available or unavailable for PUSCH transmission.

The resources occupied by UCI multiplexed in the PUSCH is the number of coded modulation symbols occupied by the UCI multiplexed in the PUSCH.

Another implementation of the method for transmitting the PUSCH and/or determining resources occupied by UCI multiplexed in the PUSCH according to the embodiment of the present disclosure may include: determining frequency domain resources related to PUSCH transmission; determining resources occupied by Uplink Control Information (UCI) multiplexed in the PUSCH based on the frequency domain resources related to PUSCH transmission; and transmitting UCI based on the determined resources occupied by the UCI multiplexed in the PUSCH; wherein, the frequency domain resources related to PUSCH transmission include the frequency domain resources assigned to the PUSCH and/or the frequency domain resources available for PUSCH transmission among the frequency domain resources assigned to the PUSCH.

The above steps are only used to label different steps and not to indicate the order of steps. In many cases, multitasking and parallel processing of steps may be advantageous.

In one implementation, the frequency domain resources assigned to the PUSCH may be frequency domain resources indicated by Frequency Domain Resource Assignment (FDRA) in the downlink control information scheduling the PUSCH, and/or frequency domain resources configured for the PUSCH by using higher-layer signaling.

In one implementation, the frequency domain resources available for PUSCH transmission among the frequency domain resources assigned to the PUSCH may be determined based on the frequency domain resources assigned to the PUSCH, as well as the frequency domain resources available and/or unavailable for PUSCH transmission.

### Embodiment I

The UE receives the second indication information transmitted by the base station, and then the UE determines the frequency domain resources unavailable for PUSCH transmission (sometimes also briefly referred to as “unavailable frequency domain resources” herein) according to the second indication information.

The second indication information may be at least one of higher-layer signaling configuration information, and information indicated by media access control layer signaling, physical layer signaling, and a reference signal. The higher-layer signaling configuration information is semi-static configuration information, and an advantage of adopting semi-static configuration information to indicate unavailable frequency domain resources is that the information is reliable and will not cause differences in understanding of unavailable frequency domain resources between the base station and the UE. The information indicated by physical layer signaling and the reference signal is dynamically indicated information; and an advantage of adopting dynamically indicated information to indicate unavailable frequency domain resources is that the information is indicated in a timely manner and may more quickly indicate the unavailable frequency domain resources to the UE. The indication information for determining the unavailable frequency domain resources may be at least one type of indication information among higher-layer signaling configuration information, information indicated by media access control layer signaling, physical layer signaling, and a reference signal (or other types of indication information); specific type of information may be preset or determined by the UE according to the indication information provided by the base station, for example, if the UE receives higher-layer signaling configuration information transmitted by the base station to the UE, then the UE determines the unavailable frequency domain resources according to the higher-layer signaling configuration information. Alternatively, if the UE receives media access control layer signaling indication transmitted by the base station to the UE, then the UE determines the unavailable frequency domain resources according to the media access control layer signaling indication. Alternatively, if the UE receives physical layer signaling indication transmitted by the base station to the UE, then the UE determines the unavailable frequency domain resources according to the physical layer signaling indication; if the UE does not receive physical layer signaling indication transmitted by the base station to the UE, and the UE receives higher-layer signaling configuration information transmitted by the base station to the UE, then the UE determines the unavailable frequency domain resources according to the higher-layer signaling configuration information. Alternatively, if the UE receives information indicated by the reference signal transmitted by the base station to the UE, then the UE determines the unavailable frequency domain resources according to the information indicated by the reference signal.

Contents of the second indication information may be at least one of the number and/or positions of downlink frequency domain resource units (e.g., PRBs, RBs, REs, REGs, etc.), the number and/or positions of uplink frequency domain resource units (e.g., PRBs, RBs, REs, REGs, etc.), the number and/or positions of flexible frequency domain resource units (e.g., PRBs, RBs, REs, REGs, etc.), and the number and/or positions of frequency domain resource units (e.g., PRBs, RBs, REs, REGs, etc.) of a guard band.

The unavailable frequency domain resources may be represented by unavailable frequency domain resource units (e.g., PRBs, RBs, REs, REGs, etc.); herein, it is described by taking unavailable PRBs as an example, which may be extended to unavailable RBs, REs, REGs, etc. without departing from the scope of the present disclosure. There are several examples below for determining unavailable frequency domain resources (for simplicity, examples below are illustrated by taking PRBs as an example).

### Example 1.1

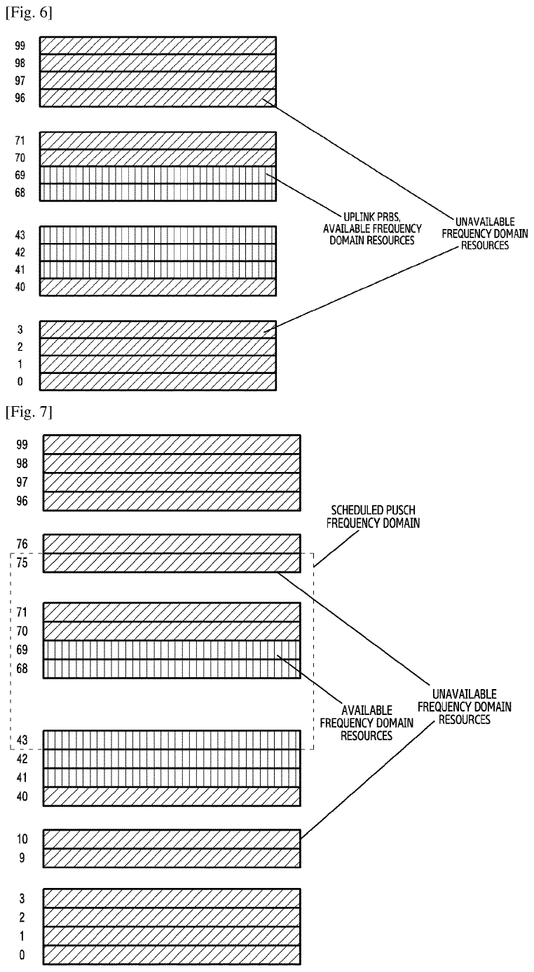

With respect to PUSCH, only indicated uplink PRBs are available frequency domain resources; and all but the indicated uplink PRBs are unavailable frequency domain resources. For example, a carrier includes 100 PRBs with sequence numbers 0-99, wherein, PRBs with sequence numbers 41-69 are uplink PRBs, PRBs with sequence numbers 41-69 are available frequency domain resources for PUSCH transmission (i.e. frequency domain resources available for PUSCH transmission), and PRBs with sequence numbers 0-40 and 70-99 are unavailable frequency domain resources for PUSCH transmission (i.e. frequency domain resources unavailable for PUSCH transmission), as shown in FIG. 6. Those skilled in the art should understand that the specific example provided in FIG. 6 is for illustrative purposes only and not for the purpose of limiting the present disclosure. According to the embodiment of the present disclosure, the sequence numbers of frequency domain resources available/unavailable for PUSCH transmission in one carrier are not limited thereto.

### Example 1.2

With respect to PUSCH, indicated uplink PRBs and indicated flexible PRBs are available frequency domain resources; and all but the indicated uplink PRBs and the indicated flexible PRBs are unavailable frequency domain resources. For example, a carrier includes 100 PRBs with sequence numbers 0-99, wherein, PRBs with sequence numbers 0-30 and 80-99 are uplink PRBs, PRBs with sequence numbers 31-50 are flexible PRBs, then PRBs with sequence numbers 0-50 and 80-99 are available frequency domain resources for PUSCH transmission, and PRBs with sequence numbers 51-79 are unavailable frequency domain resources for PUSCH transmission.

### Example 1.3

With respect to PUSCH, indicated downlink PRBs are unavailable frequency domain resources; and all but the indicated downlink PRBs are available frequency domain resources. For example, a carrier includes 100 PRBs with sequence numbers 0-99, wherein, PRBs with sequence numbers 31-50 are downlink PRBs, PRBs with sequence numbers 0-30 and 51-99 are available frequency domain resources for PUSCH transmission, and PRBs with sequence numbers 31-50 are unavailable frequency domain resources for PUSCH transmission.

### Example 1.4

With respect to PUSCH, indicated downlink PRBs and flexible PRBs are unavailable frequency domain resources for PUSCH transmission; and all but the indicated downlink PRBs and flexible PRBs are available frequency domain resources for PUSCH transmission. For example, a carrier includes 100 PRBs with sequence numbers 0-99, wherein, PRBs with sequence numbers 31-50 are downlink PRBs, PRBs with sequence numbers 51-70 are flexible PRBs, PRBs with sequence numbers 0-30 and 71-99 are available frequency domain resources for PUSCH transmission, and PRBs with sequence numbers 31-70 are unavailable frequency domain resources for PUSCH transmission.

### Example 1.5

With respect to PUSCH, indicated downlink PRBs and PRBs of a guard band are unavailable frequency domain resources for PUSCH transmission; and all but the indicated downlink PRBs and the PRBs of the guard band are available frequency domain resources for PUSCH transmission. For example, a carrier includes 100 PRBs with sequence numbers 0-99, wherein, PRBs with sequence numbers 51-70 are downlink PRBs, PRBs with sequence numbers 41-50 and 71-80 are PRBs of the guard band, and PRBs with sequence numbers 0-40 and 81-99 are available frequency domain resources for PUSCH transmission. The PRBs with sequence numbers 41-80 are unavailable frequency domain resources for PUSCH transmission.

The above available frequency domain resources for PUSCH transmission may be available frequency domain resources within a serving cell (or a carrier or a BWP). The UE receives the PRBs indicated by FDRA of scheduled PUSCH (the scheduled PUSCH includes DCI dynamically granted PUSCH, as well as static and Semi-Persistent Scheduled (SPS) PUSCH), and the PRBs indicated by the FDRA may not all be PRBs available for PUSCH transmission, that is, there are PRBs unavailable for PUSCH transmission among the PRBs indicated by FDRA, that is to say, only some PRBs among the PRBs indicated by the FDRA may be available for PUSCH transmission, for example, as shown in FIG. 7, a carrier includes 100 PRBs with sequence numbers 0-99, wherein, PRBs with sequence numbers 0-40 and 70-99 are PRBs unavailable for PUSCH transmission, PRBs with sequence numbers 41-69 are PRBs available for PUSCH transmission, and PRBs indicated by FDRA in the DCI scheduling PUSCH are PRBs with sequence numbers 43-75, then, PRBs with sequence numbers 43-69 are PRBs available for PUSCH transmission, and PRBs with sequence numbers 70-75 are PRBs unavailable for PUSCH transmission. Those skilled in the art should understand that the specific examples provided in FIG. 7 are for illustrative purposes only and not for the purpose of limiting the present disclosure. According to the embodiment of the present disclosure, the sequence numbers of PRBs available/unavailable for PUSCH transmission and PRBs indicated by FDRA in the DCI scheduling the PUSCH are not limited thereto.

In the above cases, there are several methods below for determining the number of coded modulation symbols occupied by UCI when multiplexing the UCI in the PUSCH (for simplicity, it is illustrated by taking PRBs as an example).

### Method I:

Calculating the number of coded modulation symbols for transmitting UCI in PUSCH transmission according to equation I, according to

$${M}_{sc}^{UCI} ( l ) ,$$

namely the number of subcarriers available for UCI multiplexing among the number of subcarriers of PRBs available for PUSCH transmission among the PRBs assigned for the PUSCH. And when transmitting the PUSCH, the UCI is multiplexed only on PRBs available for PUSCH transmission. For example, a carrier includes 100 PRBs with sequence numbers 0-99, wherein, PRBs with sequence numbers 0-40 and 70-99 are PRBs unavailable for PUSCH transmission, PRBs with sequence numbers 41-69 are PRBs available for PUSCH transmission, PRBs indicated by FDRA in the DCI scheduling the PUSCH are PRBs with sequence numbers 43-75, and the number M of PRBs assigned for the PUSCH by the DCI scheduling the PUSCH is equal to 75-43+1=33, wherein, PRBs with sequence numbers 43-69 are PRBs available for PUSCH transmission among the PRBs assigned for the PUSCH by the DCI scheduling the PUSCH; among the number of PRBs assigned for the PUSCH by the DCI scheduling the PUSCH M=33, the number of PRBs available for PUSCH transmission is L=69-43+1=27. The number of coded modulation symbols for multiplexing the UCI in the PUSCH Q′_{UCI} is calculated according to the number of subcarriers available for multiplexing UCI among the number of subcarriers available for the PUSCH

$${M}_{sc}^{PUSCH}$$

is equal to 27*12 subcarriers), and UCI is multiplexed in the Q′_{UCI} coded modulation symbols in the PUSCH when transmitting the PUSCH.

An advantage of adopting the method is that the number of coded modulation symbols for multiplexing UCI is determined only according to the PRBs available for transmitting the PUSCH, which may ensure that the number of coded modulation symbols occupied by the UCI does not exceed the number of coded modulation symbols available in the PUSCH.

### Method II:

Calculating the number of coded modulation symbols for transmitting UCI in PUSCH transmission according to equation II, taking the number of subcarriers M*12 of PRBs assigned for the PUSCH as

$${M}_{sc}^{PUSCH} .$$

Alternatively, calculating the number of coded modulation symbols for transmitting UCI in PUSCH transmission according to equation II, in accordance with the number of subcarriers M*12 of the PRBs assigned for the PUSCH and the number of subcarriers N*12 available for PUSCH transmission among the number of subcarriers M*12 of the PRBs assigned for the PUSCH. Wherein,

$${M}_{sc}^{UCI} ( l )$$

is the number of remaining REs in the 1-th OFDM symbol after removing the number of REs occupied by PT-RS from the number of subcarriers M*12 of the PRBs assigned for the PUSCH, and

$${N}_{sc}^{UCI} ( l )$$

is the number of remaining REs in the 1-th OFDM symbol after removing the number of REs occupied by PT-RS from the number of subcarriers N*12 available for PUSCH transmission among the number of subcarriers M*12 of the PRBs assigned for the PUSCH.

$${Q}_{UCI}^{′} = min \{ ⌈ \frac{( {O}_{UCI} + {L}_{UCI} ) \cdot {β}_{offset}^{PUSCH} {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ , {\sum }_{l = {l}_{0}}^{{N}_{symb , all}^{PUSCH} - 1} {N}_{sc}^{UCI} ( l ) \} \qquad Equation II$$

Please refer to the description of Equation I for description of items in equation II that are similar to equation I.

And when transmitting the PUSCH, the UCI is multiplexed only on the PRBs available for PUSCH transmission. For example, a carrier includes 100 PRBs with sequence numbers 0-99, wherein, PRBs with sequence numbers 0-40 and 70-99 are PRBs unavailable for PUSCH transmission, PRBs with sequence numbers 41-69 are PRBs available for PUSCH transmission, PRBs indicated by FDRA in the DCI scheduling the PUSCH are PRBs with sequence numbers 43-75, the number M of PRBs assigned for the PUSCH by the DCI scheduling the PUSCH is equal to 75-43+1=33, wherein, PRBs with sequence numbers 43-69 are PRBs available for PUSCH transmission among the PRBs assigned for the PUSCH by the DCI scheduling the PUSCH; among the number of PRBs assigned for the PUSCH by the DCI scheduling the PUSCH M=33, the number of PRBs available for PUSCH transmission is N=69-43+1=27. One calculation method is calculating the number of coded modulation symbols for transmitting UCI in PUSCH transmission according to equation I, which removes the number of subcarriers occupied by PT-RS from the number of subcarriers assigned to the PUSCH

$${M}_{sc}^{PUSCH}$$

(equals to 33*12 subcarriers) to calculate the number of coded modulation symbols for multiplexing UCI in the PUSCH Q′_{UCI}. Another calculation method is calculating the number of coded modulation symbols for transmitting UCI in PUSCH transmission according to equation II, which calculates the number of coded modulation symbols for multiplexing UCI in the PUSCH Q′_{UCI} collectively according to the number of subcarriers assigned to the PUSCH

$${M}_{sc}^{PUSCH}$$

(equals to 33*12) and the number of subcarriers

$${N}_{sc}^{PUSCH}$$

(equals to 27*12) obtained by subtracting the number of unavailable sub-carriers from the number of subcarriers assigned to the PUSCH

$${M}_{sc}^{PUSCH}$$

(equals to 33*12).

An advantage of adopting the method is that performance of UCI may be ensured as far as possible, as the resources for multiplexing UCI are calculated according to the scheduled PUSCH resources, and the resources for multiplexing UCI will not be reduced due to unavailable resources.

### Method III:

Adopting one of the method I and method II as described above is determined according to a signaling indication or in accordance with to a defined condition, to determine the number of coded modulation symbols for multiplexing UCI in the PUSCH. For example, with respect to the dynamically granted PUSCH, method I may be used to calculate the resources for multiplexing UCI, while with respect to CG-PUSCH, method II may be applied to calculate the resources for multiplexing UCI.

An optional implementation method is: receiving, by the UE, at least one of a higher-layer signaling configuration, a media access control layer signaling indication or a physical layer signaling indication, and determining the number of coded modulation symbols for multiplexing the UCI in the PUSCH by using one of method I and method II as described above. An advantage of adopting the method is that the base station may flexibly determine whether to protect performance of UCI or balance performance of UCI and data.

### Embodiment II

When a UE is configured with a plurality of serving cells, and the UE simultaneously transmits PUSCH in the plurality of serving cells, PUSCH frequency domain resources assigned for some serving cells are all available, while PUSCH frequency domain resources assigned for some serving cells are partially available and partially unavailable. Transmission of UCI in PUSCH resources will occupy PUSCH resources, and transmission of UCI will affect performance of PUSCH resources.

In order to reduce impact of multiplexing UCI on PUSCH performance as much as possible, a priority for multiplexing UCI is set to multiplex the UCI in the PUSCH; and the UE selects at least one PUSCH to multiplex the UCI according to the priority from high to low for multiplexing the UCI in the PUSCH.

### Method I:

When the UCI is to be multiplexed in at least 2 time-overlapping PUSCHs, the priority for multiplexing UCI in the PUSCH whose assigned PUSCH frequency domain resources are all available is higher than the priority for multiplexing UCI in the PUSCH whose assigned PUSCH frequency domain resources include unavailable frequency domain resources. An advantage of adopting the method is that impact of UCI multiplexing on PUSCH resources may be reduced as much as possible, because multiplexing UCI in the PUSCH whose assigned PUSCH frequency domain resources are all available has a small impact on the PUSCH, while including unavailable frequency domain resources in assigned PUSCH frequency domain resources has already had an impact on PUSCH performance, and further multiplexing UCI in the PUSCH has a greater impact on the PUSCH.

In one implementation, if there are a plurality of PUSCHs whose assigned PUSCH frequency domain resources are all available for PUSCH transmission in a time unit on the serving cell, then UCI is multiplexed in a PUSCH of a serving cell having minimum serving cell index ServCellIndex. Further, if there are more than one PUSCHs whose PUSCH frequency domain resource are all available for PUSCH transmission in a time unit on a serving cell having minimum ServCellIndex, then UCI is multiplexed in an earliest PUSCH transmitted by the UE in the time unit.

In one implementation, if there are a plurality of dynamically granted PUSCHs whose assigned PUSCH frequency domain resources are all available for PUSCH transmission in a time unit on the serving cell, then UCI is multiplexed in a dynamically granted PUSCH of the serving cell having minimum ServCellIndex. Further, if there are more than one dynamically granted PUSCHs whose PUSCH frequency domain resource are all available for PUSCH transmission in a time unit on a serving cell having minimum ServCellIndex, then UCI is multiplexed in an earliest dynamically granted PUSCH transmitted by the UE in the time unit.

In one implementation, if there are a plurality of configuration granted PUSCHs whose assigned PUSCH frequency domain resources are all available for PUSCH transmission in a time unit on the serving cell, then UCI is multiplexed in a configuration granted PUSCH of the serving cell having minimum ServCellIndex. Further, if there are more than one configuration granted PUSCHs whose PUSCH frequency domain resources are all available for PUSCH transmission in a time unit on a serving cell having minimum ServCellIndex, then UCI is multiplexed in an earliest configured PUSCH transmitted by the UE in the time unit.

### Method II:

When UCI is to be multiplexed in at least 2 time-overlapping PUSCHs, a class a PUSCH is a PUSCH whose assigned PUSCH frequency domain resources are all available, and which is a DCI Dynamically Granted PUSCH (DG-PUSCH). A class b PUSCH is a PUSCH whose assigned PUSCH frequency domain resources are all available, and which is a Configuration Granted-PUSCH. A class c PUSCH is a PUSCH whose assigned PUSCH frequency domain resources include unavailable frequency domain resources, and which is a DCI Dynamically Granted PUSCH (DG-PUSCH). A class d PUSCH is a PUSCH whose assigned PUSCH frequency domain resources include unavailable frequency domain resources, and which is a Configuration Granted-PUSCH (CG-PUSCH). One type of order of priorities for multiplexing UCI in PUSCH is: a>b>c>d. Another type of order of priorities for multiplexing UCI in PUSCH is: a>c>b>d. An advantage of adopting the method is that impact of UCI multiplexing on PUSCH resources is reduced as much as possible. With respect to the dynamically granted PUSCH, the base station may reduce impact of multiplexing UCI on the PUSCH by adjusting an encoding rate of the PUSCH, while with respect to CG PUSCH, impact of multiplexing UCI on the PUSCH cannot be reduced by adjusting the encoding rate of the PUSCH. Therefore, priority is given to multiplexing UCI in the dynamically granted PUSCH, so that impact on the PUSCH resources is small.

In one implementation, if there are a plurality of PUSCHs whose assigned PUSCH frequency domain resources are partially available for PUSCH transmission in a time unit on the serving cell, then UCI is multiplexed in a PUSCH of the serving cell having minimum ServCellIndex. Further, if there are more than one PUSCHs whose PUSCH frequency domain resources are partially available for PUSCH transmission in a time unit on a serving cell having minimum ServCellIndex, then UCI is multiplexed in an earliest PUSCH transmitted by the UE in the time unit.

In one implementation, if there are a plurality of dynamically granted PUSCHs whose assigned PUSCH frequency domain resources are partially available for PUSCH transmission in a time unit on the serving cell, then UCI is multiplexed in a dynamically granted PUSCH of the serving cell having minimum ServCellIndex. Further, if there are more than one dynamically granted PUSCHs whose PUSCH frequency domain resources are partially available for PUSCH transmission in a time unit on a serving cell having minimum ServCellIndex, then UCI is multiplexed in an earliest dynamically granted PUSCH transmitted by the UE in the time unit.

In one implementation, if there are a plurality of configuration granted PUSCHs whose assigned PUSCH frequency domain resources are partially available for PUSCH transmission in a time unit on the serving cell, then UCI is multiplexed in a configuration granted PUSCH of the serving cell having minimum ServCellIndex. Further, if there are more than one configuration granted PUSCHs whose PUSCH frequency domain resources are partially available for PUSCH transmission in a time unit on a serving cell having minimum ServCellIndex, then UCI is multiplexed in an earliest configuration granted PUSCH transmitted by the UE in the time unit.

According to an embodiment of the present disclosure, there is further provided a method for receiving PUSCH and/or determining resources occupied by UCI multiplexed in PUSCH. The method may be executed by the base station for at least one UE communicating with the base station.

In one implementation, the method may include: determining frequency domain resources related to Physical Uplink Shared Channel (PUSCH) transmission; and determining resources occupied by Uplink Control Information (UCI) multiplexed in the PUSCH based on the frequency domain resources related to PUSCH transmission, and receiving the UCI based on the determined resources occupied by the UCI multiplexed in the PUSCH; wherein, the frequency domain resources related to PUSCH transmission include frequency domain resources assigned to the PUSCH or frequency domain resources available for PUSCH transmission among the frequency domain resources assigned to the PUSCH.

With respect to at least one UE, the base station determines the frequency domain resources assigned to the PUSCH of the UE, and generates and transmits first indication information to the UE, to indicate the frequency domain resources assigned to the PUSCH of the UE.

In one implementation, the method may further include: with respect to the UE, determining, by the base station, frequency domain resources of the UE that are available or unavailable for PUSCH transmission, and generating and transmitting second indication information to the UE, to indicate frequency domain resources of the UE that are available or unavailable for PUSCH transmission.

In one implementation, the method may further include: with respect to the UE, determining, by the base station, resources occupied by the UCI multiplexed by the UE in the PUSCH according to the frequency domain resources assigned to the PUSCH of the UE and the frequency domain resources of the UE that are available or unavailable for PUSCH transmission. The base station receives UCI from the UE on the resources occupied by the UCI multiplexed in the PUSCH.

The resources occupied by the UCI multiplexed in PUSCH is the number of coded modulation symbols occupied by the UCI multiplexed in the PUSCH.

The above steps are only used to label different steps and not to indicate the order of the steps.

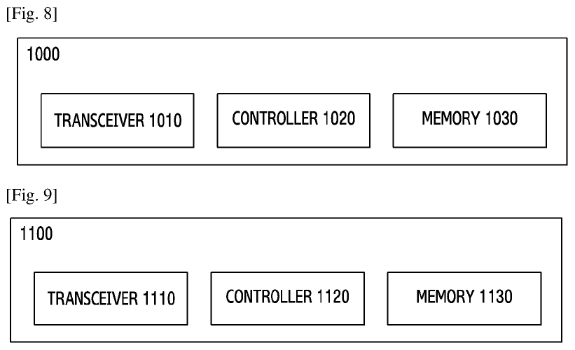

FIG. 8 is a block diagram of a node according to an exemplary embodiment of the present disclosure. Here, a node is taken as an example to illustrate a structure and a function thereof, but it should be understood that, the structure and the function shown may also be applied to a base station.

Referring to FIG. 8, the node 1000 includes a transceiver 1010, a controller 1020 and a memory 1030. Under control of the controller 1020 (which may be implemented as one or more processors), the node 1000 (including the transceiver 1010 and the memory 1030) is configured to execute operations of the node as described above. However, the components of the base station are not limited thereto. For example, the base station may include more or fewer components than those described above. Although the transceiver 1010, the controller 1020, and the memory 1030 are shown as separate entities, they may be implemented as a single entity, for example, a single chip. The transceiver 1010, the controller 1020, and the memory 1030 may be electrically connected with or coupled to each other. Also, the controller 1020 may include at least one processor. Furthermore, the base station of FIG. 8 corresponds to the BSs of FIG. 1.

The transceiver 1010 may transmit and receive signals to and from other network entities; the other network entities are, for example, other nodes and/or UEs, etc. In one implementation, the transceiver 1010 may be omitted. In this case, the controller 1020 may be configured to execute instructions (including computer programs) stored in the memory 1030 to control overall operation of the node 1000, so as to implement the operations of the node as described above.

The transceiver 1010 collectively refers to a base station receiver and a base station transmitter, and may transmit/receive a signal to/from a terminal (UE) or a network entity. The signal transmitted or received to or from the terminal or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the controller 1020, a signal through a wireless channel, and transmit a signal output from the controller 1020 through the wireless channel.

The memory 1030 may store a program and data required for operations of the base station. Also, the memory 1030 may store control information or data included in a signal obtained by the base station. The memory 1030 may be a storage medium, such as read-only memory (ROM), random access memory (RAM), a hard disk, a CDROM, and a DVD, or a combination of storage media.

The controller 1020 may control a series of processes such that the base station operates as described above. For example, the transceiver 1010 may receive a data signal including a control signal transmitted by the terminal, and the controller 1020 may determine a result of receiving the control signal and the data signal transmitted by the terminal.

FIG. 9 is a block diagram of a user equipment according to an exemplary embodiment of the present disclosure. In the present disclosure, the terms “user equipment”, “user terminal equipment”, “user terminal”, “terminal” and “terminal equipment” may be interchangeably used.

Referring to FIG. 9, the user equipment 1100 includes a transceiver 1110, a controller 1120 and a memory 1130. Under control of the controller 1120 (which may be implemented as one or more processors), the user equipment 1100 (including the transceiver 1110 and the memory 1130) is configured to execute operations of the user equipment as described above. However, the components of the UE are not limited thereto. For example, the UE may include more or fewer components than those described above. Although the transceiver 1110, the controller 1120, and the memory 1130 are shown as separate entities, they may be implemented as a single entity, for example, a single chip. The transceiver 1110, the controller 1120, and the memory 1130 may be electrically connected with or coupled to each other. Also, the controller 1120 may include at least one processor. Furthermore, the UE of FIG. 9 corresponds to the UEs of FIG. 1.

The transceiver 1110 may transmit and receive signals to and from other network entities; the other network entities are, for example, nodes and/or other UEs, etc. In one implementation, the transceiver 1110 may be omitted. In this case, the controller 1120 may be configured to execute instructions (including computer programs) stored in the memory 1130 to control overall operation of the user equipment 1100, so as to perform the operations of the user equipment as described above.

The transceiver 1110 collectively refers to a UE receiver and a UE transmitter, and may transmit/receive a signal to/from a base station or a network entity. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the controller 1120, a signal through a wireless channel, and transmit a signal output from the controller 1120 through the wireless channel.

The memory 1130 may store a program and data required for operations of the UE. Also, the memory 1130 may store control information or data included in a signal obtained by the UE. The memory 1130 may be a storage medium, such as read-only memory (ROM), random access memory (RAM), a hard disk, a CD-ROM, and a DVD, or a combination of storage media.

The controller 1120 may control a series of processes such that the UE operates as described above. For example, the transceiver 1110 may receive a data signal including a control signal transmitted by the base station or the network entity, and the controller 1120 may determine a result of receiving the control signal and the data signal transmitted by the base station or the network entity.

Those skilled in the art may realize that the present disclosure may be implemented in other specific forms without changing the technical idea or basic features of the present disclosure. Therefore, it should be understood that, the above-described embodiments are merely examples and not limitative. The scope of the present disclosure is defined by the appended claims rather than the detailed description. Therefore, it should be understood that all modifications or changes derived from the meaning and scope of the appended claims and their equivalents fall within the scope of the present disclosure.

In the above-described embodiments of the present disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the present disclosure has been illustrated and described with reference to various embodiments of the present disclosure, those skilled in the art will understand that various changes can be made in form and detail without departing from the spirit and scope of the present disclosure as defined by the appended claims and their equivalents.

The above are merely preferred embodiments of the present disclosure, and are not intended to limit the present disclosure. Any modification, equivalent substitution, improvement, and the like, made within the spirit and principles of the present disclosure should be covered within the protection scope of the present disclosure.

1. A method performed by a terminal in a wireless communication system, the method comprising:
determining frequency domain resources related to a physical uplink shared channel (PUSCH) transmission;
determining resources occupied by uplink control information (UCI) multiplexed in a PUSCH based on the frequency domain resources related to the PUSCH transmission; and
transmitting the UCI based on the determined resources occupied by the UCI multiplexed in the PUSCH,
wherein, the frequency domain resources related to the PUSCH transmission comprise at least one of frequency domain resources assigned to the PUSCH or frequency domain resources available for PUSCH transmission among the frequency domain resources assigned to the PUSCH.

2. The method of claim 1, wherein, the frequency domain resources assigned to the PUSCH are at least one of frequency domain resources indicated by a frequency domain resource assignment (FDRA) in the downlink control information scheduling the PUSCH, or frequency domain resources configured for the PUSCH by using higher-layer signaling.

3. The method of claim 1,
wherein, the frequency domain resources available for PUSCH transmission among the frequency domain resources assigned to the PUSCH are determined based on the frequency domain resources assigned to the PUSCH, as well as frequency domain resources available or unavailable for the PUSCH transmission,
wherein, the frequency domain resources available or unavailable for the PUSCH transmission are determined based on indication information; the indication information comprises at least one of higher-layer signaling configuration information, information indicated by a media access control layer signaling, information indicated by a physical layer signaling, and information indicated by a reference signal, and
wherein the indication information comprises at least one of the number or positions of downlink frequency domain resource units, the number or positions of uplink frequency domain resource units, the number or positions of flexible frequency domain resource units, and the number or positions of frequency domain resource units of a guard band.

4. The method of claim 1, wherein, the frequency domain resources available for the PUSCH transmission are available frequency domain resources within a serving cell, a carrier, or a bandwidth part (BWP).

5. A method performed by a base station in a wireless communication system, the method comprising:
determining frequency domain resources related to a physical uplink shared channel (PUSCH) transmission;
determining resources occupied by uplink control information (UCI) multiplexed in a PUSCH based on the frequency domain resources related to the PUSCH transmission; and
receiving the UCI based on the determined resources occupied by the UCI multiplexed in the PUSCH,
wherein, the frequency domain resources related to the PUSCH transmission comprise frequency domain resources assigned to the PUSCH or frequency domain resources available for the PUSCH transmission among the frequency domain resources assigned to the PUSCH.

6. The method of claim 5, wherein, the frequency domain resources assigned to the PUSCH are at least one of frequency domain resources indicated by a frequency domain resource assignment (FDRA) in the downlink control information scheduling the PUSCH, or frequency domain resources configured for the PUSCH by using higher-layer signaling.

7. The method of claim 5,
wherein, the frequency domain resources available for PUSCH transmission among the frequency domain resources assigned to the PUSCH are determined based on the frequency domain resources assigned to the PUSCH, as well as frequency domain resources available or unavailable for the PUSCH transmission,
wherein, the frequency domain resources available or unavailable for the PUSCH transmission are determined based on indication information; the indication information comprises at least one of higher-layer signaling configuration information, information indicated by a media access control layer signaling, information indicated by a physical layer signaling, and information indicated by a reference signal, and
wherein the indication information comprises at least one of the number or positions of downlink frequency domain resource units, the number or positions of uplink frequency domain resource units, the number or positions of flexible frequency domain resource units, and the number or positions of frequency domain resource units of a guard band.

8. The method of claim 5, wherein, the frequency domain resources available for the PUSCH transmission are available frequency domain resources within a serving cell, a carrier, or a bandwidth part (BWP).

9. A terminal in a wireless communication system, the terminal comprising:
a transceiver; and
a controller coupled with the transceiver and configured to:
determine frequency domain resources related to a physical uplink shared channel (PUSCH) transmission,
determine resources occupied by uplink control information (UCI) multiplexed in a PUSCH based on the frequency domain resources related to the PUSCH transmission, and
transmit the UCI based on the determined resources occupied by the UCI multiplexed in the PUSCH,
wherein, the frequency domain resources related to the PUSCH transmission comprise at least one of frequency domain resources assigned to the PUSCH or frequency domain resources available for PUSCH transmission among the frequency domain resources assigned to the PUSCH.

10. The terminal of claim 9, wherein, the frequency domain resources assigned to the PUSCH are at least one of frequency domain resources indicated by a frequency domain resource assignment (FDRA) in the downlink control information scheduling the PUSCH, or frequency domain resources configured for the PUSCH by using higher-layer signaling.

11. The terminal of claim 9,
wherein, the frequency domain resources available for PUSCH transmission among the frequency domain resources assigned to the PUSCH are determined based on the frequency domain resources assigned to the PUSCH, as well as frequency domain resources available or unavailable for the PUSCH transmission,
wherein, the frequency domain resources available or unavailable for the PUSCH transmission are determined based on indication information; the indication information comprises at least one of higher-layer signaling configuration information, information indicated by a media access control layer signaling, information indicated by a physical layer signaling, and information indicated by a reference signal, and
wherein the indication information comprises at least one of the number or positions of downlink frequency domain resource units, the number or positions of uplink frequency domain resource units, the number or positions of flexible frequency domain resource units, and the number or positions of frequency domain resource units of a guard band.

12. The terminal of claim 9, wherein, the frequency domain resources available for the PUSCH transmission are available frequency domain resources within a serving cell, a carrier, or a bandwidth part (BWP).

13. A base station in a wireless communication system, the base station comprising:
a transceiver; and
a controller coupled with the transceiver and configured to:
determine frequency domain resources related to a physical uplink shared channel (PUSCH) transmission,
determine resources occupied by uplink control information (UCI) multiplexed in a PUSCH based on the frequency domain resources related to the PUSCH transmission, and
receive the UCI based on the determined resources occupied by the UCI multiplexed in the PUSCH,
wherein, the frequency domain resources related to the PUSCH transmission comprise frequency domain resources assigned to the PUSCH or frequency domain resources available for the PUSCH transmission among the frequency domain resources assigned to the PUSCH.

14. The base station of claim 13, wherein, the frequency domain resources assigned to the PUSCH are at least one of frequency domain resources indicated by a frequency domain resource assignment (FDRA) in the downlink control information scheduling the PUSCH, or frequency domain resources configured for the PUSCH by using higher-layer signaling.

15. The base station of claim 13,
wherein, the frequency domain resources available for PUSCH transmission among the frequency domain resources assigned to the PUSCH are determined based on the frequency domain resources assigned to the PUSCH, as well as frequency domain resources available or unavailable for the PUSCH transmission,
wherein, the frequency domain resources available or unavailable for the PUSCH transmission are determined based on indication information; the indication information comprises at least one of higher-layer signaling configuration information, information indicated by a media access control layer signaling, information indicated by a physical layer signaling, and information indicated by a reference signal, and
wherein the indication information comprises at least one of the number or positions of downlink frequency domain resource units, the number or positions of uplink frequency domain resource units, the number or positions of flexible frequency domain resource units, and the number or positions of frequency domain resource units of a guard band.
